(19) United States
(12) Patent Application Publication
(10) Pub. No.: US 2026/0318719 A1
(43) Pub. Date: Oct. 15, 2026

(54) ELECTRONIC DEVICE AND PIVOT ANGLE SENSING METHOD THEREOF

(71) Applicant: Elite Semiconductor Microelectronics Technology Inc., Hsinchu (TW)

(72) Inventors: Hung-Jui Ting, Hsinchu (TW); Teng-Chi Yang, Hsinchu (TW); Dar-Chang Juang, Hsinchu (TW)

(73) Assignee: Elite Semiconductor Microelectronics Technology Inc., Hsinchu (TW)

(21) Appl. No.: 19/560,170

(22) Filed: Mar. 9, 2026

Related U.S. Application Data
(60) Provisional application No. 63/788,127, filed on Apr. 14, 2025.

(51) Int. Cl. G01D 5/347

(52) U.S. Cl. CPC G01D 5/34715

(57) ABSTRACT

An electronic device includes first and second device bodies, a pivot base, a pivot sleeve and an optical sensing device disposed on the pivot base. The pivot base is pivoted to the first and second device bodies, such that the second device body is pivotable via the pivot base. The pivot sleeve is sleeved at a pivotal connection position between the pivot base and the second device body to pivot together with the second device body and is formed with a color variation pattern or a reflective structure. Light emitted by the optical sensing device is incident upon the color variation pattern or a reflective structure and reflected to the optical sensing device when the pivot sleeve pivots, such that the optical sensing device generates an optical sensing signal corresponding to a pivot angle of the pivot sleeve according to a light reflection amount received by the optical sensing device.

### CROSS REFERENCE TO RELATED APPLICATIONS

This application claims the benefit of U.S. Provisional Application No. 63/788,127, filed on Apr. 14th, 2025. The content of the application is incorporated herein by reference.

### BACKGROUND OF THE INVENTION

### 1.Field of the Invention

The present invention relates to an electronic device and a pivot angle sensing method thereof, and more specifically, to an electronic device sleeving a pivot sleeve formed with a color variation pattern at a pivotal connection position of the electronic device and utilizing an optical sensor to detect a light reflection amount of the color variation pattern for determining a pivot angle of the pivot sleeve and a pivot angle sensing method thereof.

### 2. Description of the Prior Art

In general, an electronic device with a foldable function, such as a laptop computer, usually utilizes a magnetic sensing design with a magnet and a Hall sensor to monitor a power-on or power-off state of the electronic device. For example, when the laptop computer is opened or closed, the magnet is moved correspondingly away from or toward the Hall sensor, causing a change in the magnetic flux sensed by the Hall sensor and thus generating a voltage difference. As such, the power-on or power-off state of the laptop computer could be detected according to the voltage difference.

With the development of the thinning design of the electronic device, the size of the magnet is inevitably reduced, resulting in decreased magnetic force. Accordingly, the magnet must be positioned relatively close to the Hall sensor for detecting a change in the magnetic flux sufficient to trigger a power-on or power-off signal.

However, different types or brands of electronic devices define different trigger angles for determining the power-on and power-off states. When a large-angle power-on/off detection function is required, the aforementioned thinning magnet design fails to provide sufficient magnetic force, which may easily lead to sensing failure or misjudgment, thereby causing users much operational inconvenience.

### SUMMARY OF THE INVENTION

Thus, one purpose of the present invention is to provide an electronic device sleeving a pivot sleeve formed with a color variation pattern at a pivotal connection position of the electronic device and utilizing an optical sensor to detect a light reflection amount of the color variation pattern for determining a pivot angle of the pivot sleeve and a pivot angle sensing method thereof, for solving the aforesaid problems.

According to one embodiment, an electronic device of the present invention includes a first device body, a second device body, a pivot base, a pivot sleeve, and an optical sensing device. The pivot base is disposed on the first device body and pivotally connected to the second device body, such that the second device body is pivotable relative to the first device body to an unfolded position or a folded position via the pivot base. The pivot sleeve is sleeved at a pivotal connection position between the pivot base and the second device body to pivot together with the second device body. The pivot sleeve is formed with a color variation pattern or a reflective structure. The optical sensing device is disposed on the pivot base or the first device body. The optical sensing device includes an optical emitting component and an optical receiving component. Light emitted by the optical emitting component is incident upon the color variation pattern or the reflective structure and reflected to the optical receiving component when the pivot sleeve pivots, such that the optical sensing device generates an optical sensing signal corresponding to a pivot angle of the pivot sleeve according to at least one light reflection amount received by the optical receiving component.

According to another embodiment, a pivot angle sensing method of the present invention is used for an electronic device. The electronic device includes a first device body, a second device body and a pivot base. The pivot base is disposed on the first device body and pivotally connected to the second device body, such that the second device body is pivotable relative to the first device body to an unfolded position or a folded position via the pivot base. The pivot angle sensing method includes emitting light from an optical sensing device toward a pivot sleeve, wherein the pivot sleeve is sleeved at a pivotal connection position between the pivot base and the second device body of the electronic device and is formed with a color variation pattern or a reflective structure. The pivot angle sensing method further includes receiving a reflected light from the color variation pattern or the reflective structure by the optical sensing device as the pivot sleeve pivots together with the second device body and generating an optical sensing signal corresponding to a pivot angle of the pivot sleeve according to a light reflection amount received by the optical sensing device.

In summary, via the optical sensing design in which the pivot sleeve having the color variation pattern formed thereon is sleeved at the pivotal connection position of the electronic device and the optical sensor is utilized to detect the light reflection amount of the color variation pattern as the pivot sleeve pivots, the present invention can accurately determine the pivot angle of the pivot sleeve that pivots synchronously with the electronic device, and accordingly perform subsequent control operations (e.g., triggering booting/shutdown procedures or entering a sleep mode) for the electronic device. As such, via the precise detection for the pivot angle of the pivot sleeve, the present invention not only meets different application requirements of various types/brands of electronic devices regarding definition of trigger angles for determining the power-on and power-off states, but also solves the prior art problem that the insufficient magnetic force of the thinning magnet leads to sensing failure or misjudgment which prevents accurate execution of power-on/off detection functions. In such a manner, the present invention significantly improves the operational convenience and user experience of the electronic device. Furthermore, the present invention is advantageous for the thinning design of the electronic device since a sensing chip required for the optical sensing device is extremely small in size (e.g., approximately 2mm x 1mm).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a side view of an electronic device according to an embodiment of the present invention.

FIG. 2 is a flowchart of a pivot angle sensing method according to an embodiment of the present invention.

FIG. 3 shows a color variation pattern of a pivot sleeve in FIG. 1 and the correspondence between the light reflection amount and pivot angle of the pivot sleeve.

FIG. 4 is a side view of an electronic device according to another embodiment of the present invention.

FIG. 5 shows a color variation pattern of a pivot sleeve in FIG. 4 and the correspondence between the light reflection amount difference and pivot angle of the pivot sleeve.

FIG. 6 is a side view of an electronic device according to another embodiment of the present invention.

FIG. 7 is a side view of an electronic device according to another embodiment of the present invention.

FIG. 8 is a side view of an electronic device according to another embodiment of the present invention.

FIG. 9 is a side view of an electronic device according to another embodiment of the present invention.

### DETAILED DESCRIPTION

The present invention will now be described more specifically with reference to the following embodiments and the accompanying drawings. Other advantages and effects of the present invention can be easily understood by a person ordinarily skilled in the art in view of the detailed descriptions and the accompanying drawings. The present invention can be implemented or applied to other different embodiments. Certain aspects of the present invention are not limited by the particular details of the examples illustrated herein. Without departing from the spirit and scope of the present invention, the present invention will have other modifications and changes. It should be understood that the appended drawings are not necessarily drawn to the scale and configuration of each component (e.g., structural scales of an electronic device and an optical sensing device) in the drawings is merely illustrative, not presenting an actual condition of the embodiments.

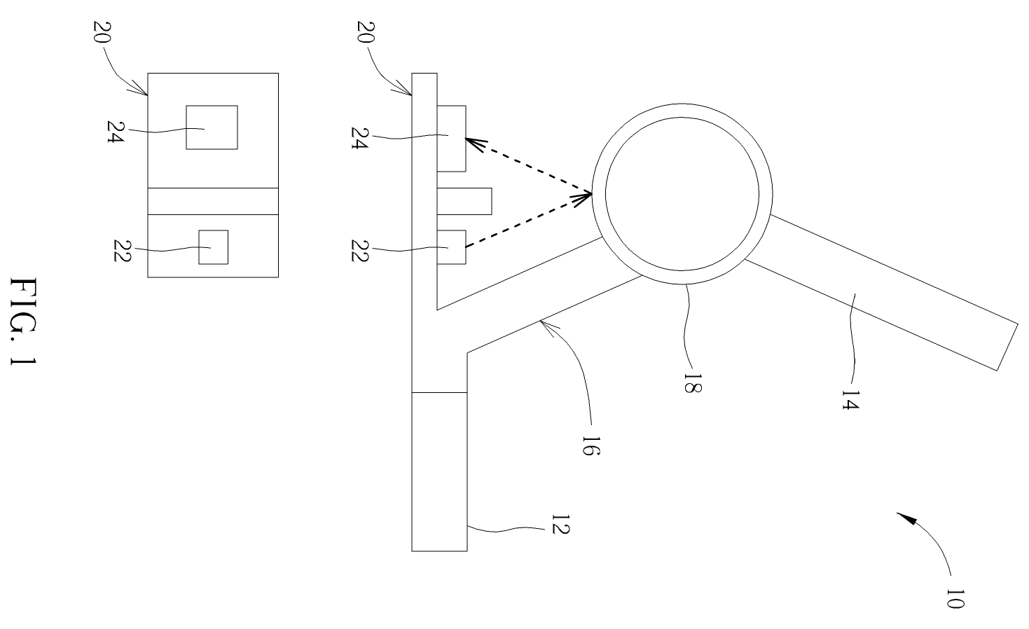

Please refer to FIG. 1, which is a side view of an electronic device 10 according to an embodiment of the present invention. As shown in FIG. 1, the electronic device 10 could be preferably an electronic apparatus with a foldable function (e.g., a laptop computer, but not limited thereto). For clearly showing the optical sensing design within the electronic device 10, components of the electronic device 10 are depicted as simple blocks in FIG. 1. In this embodiment, the electronic device 10 includes a first device body 12 (e.g., a computer host), a second device body 14 (e.g., a display screen), a pivot base 16, a pivot sleeve 18, and an optical sensing device 20. Since the related description for the first device body 12 and the second device body 14 is commonly seen in the prior art, it is omitted herein.

The pivot base 16 is disposed on the first device body 12 and is pivotally connected to the second device body 14 (e.g., via a pivot shaft), such that the second device body 14 can pivot relative to the first device body 12 via the pivot base 16 to an unfolded position for user operations (e.g., viewing images, performing document work, etc.), or pivot to a folded position for carrying or storage.

The pivot sleeve 18 is sleeved at a pivotal connection position between the pivot base 16 and the second device body 14, so as to pivot together with the second device body 14. In this embodiment, the pivot sleeve 18 could be formed with a color variation pattern 19.

The optical sensing device 20 could be disposed on the pivot base 16 (but not limited thereto, meaning that the optical sensing device 20 could be disposed on the first device body 12 in another embodiment) and includes an optical emitting component 22 and an optical receiving component 24. The optical sensing device 20 could preferably adopt an infrared sensing design (but not limited thereto, meaning that the present invention could adopt other optical sensing designs, such as visible light sensing designs). For example, the optical emitting component 22 could be an infrared (IR) emitter for emitting infrared light, and the optical receiving component 24 could be a phototransistor (PT) receiver for receiving the infrared light.

Via the aforesaid design, when the second device body 14 pivots relative to the first device body 12 to make the pivot sleeve 18 pivot accordingly, light emitted by the optical emitting component 22 is incident upon the color variation pattern 19 and reflected to the optical receiving component 24 (as shown in FIG. 1). As such, the optical sensing device 20 generates an optical sensing signal corresponding to a pivot angle of the pivot sleeve 18 (e.g., corresponding to a large angle where the second device body 14 is in the unfolded position, or a small angle where the second device body 14 is in the folded position) according to a light reflection amount received by the optical receiving component 24. In such a manner, the electronic device 10 can perform corresponding control operations according to the optical sensing signal, such as triggering a booting/shutdown procedure or entering a sleep mode. As for the related description for the transmission control of the optical sensing signal between the optical sensing device 20 and the electronic device 10, it is commonly seen in the prior art and omitted herein.

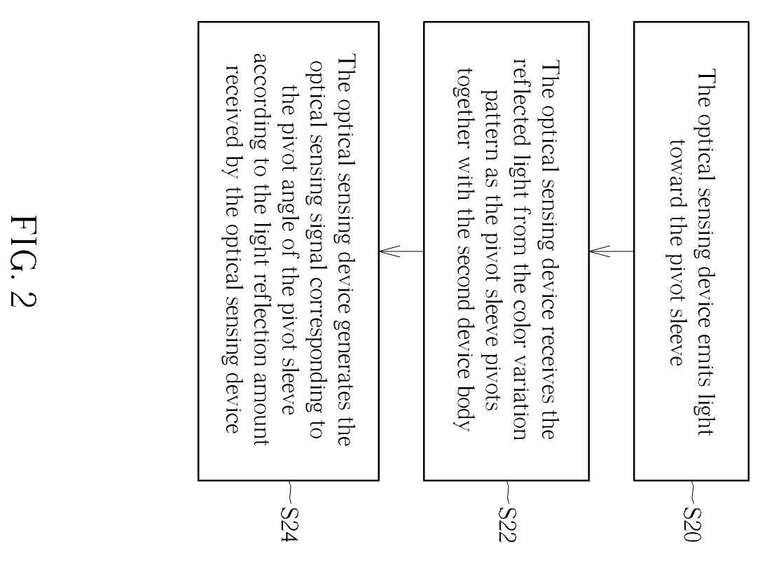

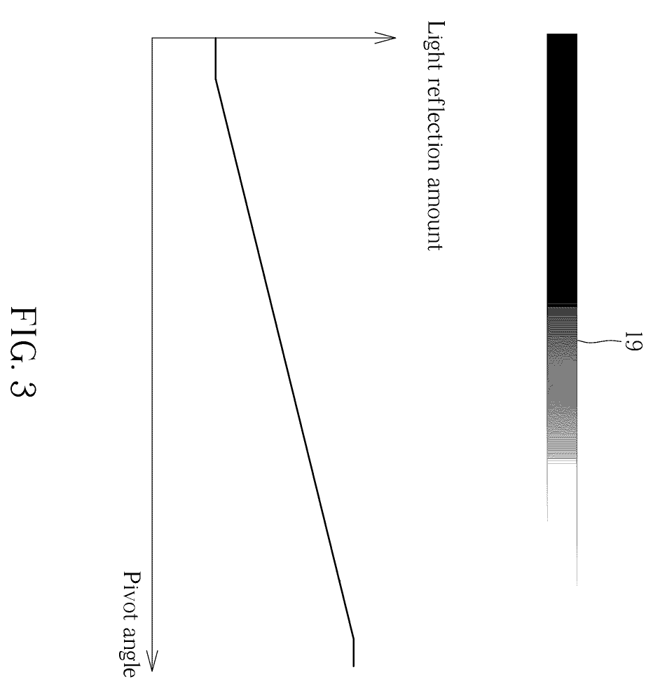

More detailed description for a pivot angle sensing method of the present invention is provided as follows. Please refer to FIGS. 1, 2, and 3. . FIG. 2 is a flowchart of a pivot angle sensing method according to an embodiment of the present invention. FIG. 3 shows the color variation pattern 19 of the pivot sleeve 18 in FIG. 1 and the correspondence between the light reflection amount and pivot angle of the pivot sleeve 18.

First, in step S20, the optical sensing device 20 is disposed at a position corresponding to the pivot sleeve 18 (as shown in FIG. 1) and emits light toward the pivot sleeve 18, wherein the pivot sleeve 18 is sleeved at the pivotal connection position between the pivot base 16 and the second device body 14, such that the pivot sleeve 18 with the color variation pattern 19 can pivot together with the second device body 14. As shown in FIG. 3, the color variation pattern 19 could present a grayscale gradient distribution along a periphery of the pivot sleeve 18.

Next, in step S22, the optical sensing device 20 can receive a reflected light from the color variation pattern 19 as the pivot sleeve 18 pivots together with the second device body 14, so as to perform optical sensing on the pivot angle of the pivot sleeve 18. For example, during the process of the second device body 14 pivoting together with the pivot sleeve 18 relative to the first device body 12, if the second device body 14 pivots to the folded position where the light from the optical emitting component 22 is incident upon a section having a higher grayscale value within the color variation pattern 19 (e.g., a black section located at a leftmost portion of the color variation pattern 19 as shown in FIG. 3), the optical receiving component 24 receives a lower light reflection amount. Accordingly, in step S24, the optical sensing device 20 can determine that the second device body 14 has currently pivoted to the folded position based on an optical sensing signal transmitted from the optical receiving component 24 (e.g., using whether the light reflection amount is lower than a predetermined value as a determination basis), and thus proceed with subsequent control operations, such as triggering a shutdown procedure or entering a sleep mode.

On the other hand, if the second device body 14 pivots to the unfolded position such that the light from the optical emitting component 22 is incident upon a section having a lower grayscale value within the color variation pattern 19 (e.g., a white section located at a rightmost portion of the color variation pattern 19 as shown in FIG. 3), the optical receiving component 24 receives a higher light reflection amount. Accordingly, in step 24, the optical sensing device 20 can determine that the second device body 14 has currently pivoted to the unfolded position based on the optical sensing signal transmitted from the optical receiving component 24 (e.g., using whether the light reflection amount is higher than a predetermined value as a determination basis), and thus proceed with subsequent control operations, such as triggering a booting procedure.

To be noted, in another embodiment, the present invention could adopt the pattern design in which the optical sensing device 20 can determine that the second device body 14 has currently pivoted to the folded position when the light is incident upon a section having a lower grayscale value within a color variation pattern, and determine that the second device body 14 has currently pivoted to the unfolded position when the light is incident upon a section having a higher grayscale value within the color variation pattern. The detailed description for this embodiment could be reasoned by analogy according to FIG. 3 and omitted herein. As for which pattern design is adopted, it depends on the practical applications of the present invention.

In summary, via the optical sensing design in which the pivot sleeve having the color variation pattern formed thereon is sleeved at the pivotal connection position of the electronic device and the optical sensor is utilized to detect the light reflection amount of the color variation pattern as the pivot sleeve pivots, the present invention can accurately determine the pivot angle of the pivot sleeve that pivots synchronously with the electronic device, and accordingly perform subsequent control operations (e.g., triggering booting/shutdown procedures or entering a sleep mode) for the electronic device. As such, via the precise detection for the pivot angle of the pivot sleeve, the present invention not only meets different application requirements of various types/brands of electronic devices regarding definition of trigger angles for determining the power-on and power-off states, but also solves the prior art problem that the insufficient magnetic force of the thinning magnet leads to sensing failure or misjudgment which prevents accurate execution of power-on/off detection functions. In such a manner, the present invention significantly improves the operational convenience and user experience of the electronic device. Furthermore, the present invention is advantageous for the thinning design of the electronic device since a sensing chip required for the optical sensing device is extremely small in size (e.g., approximately 2mm x 1mm).

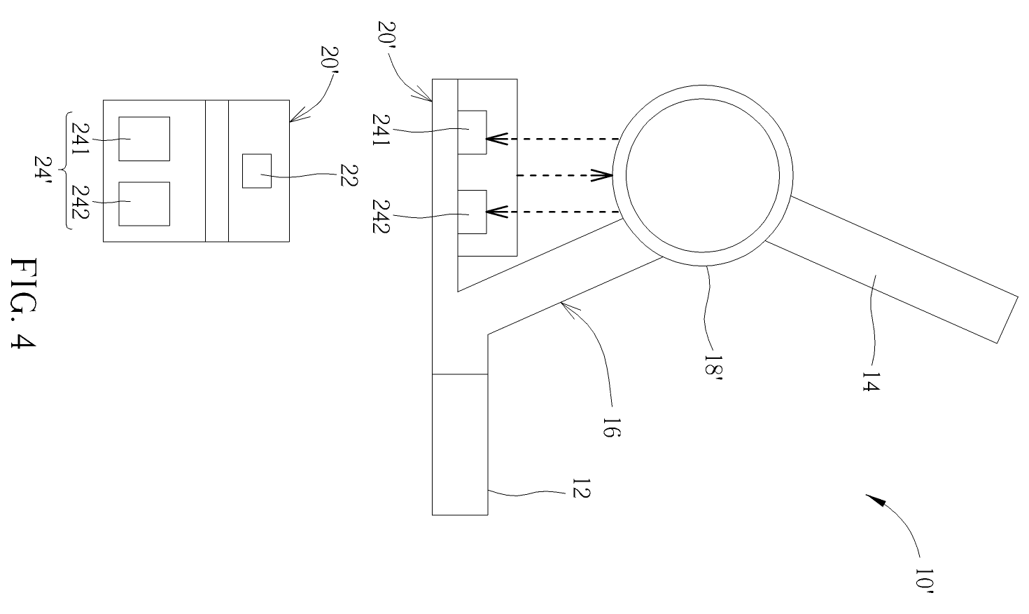

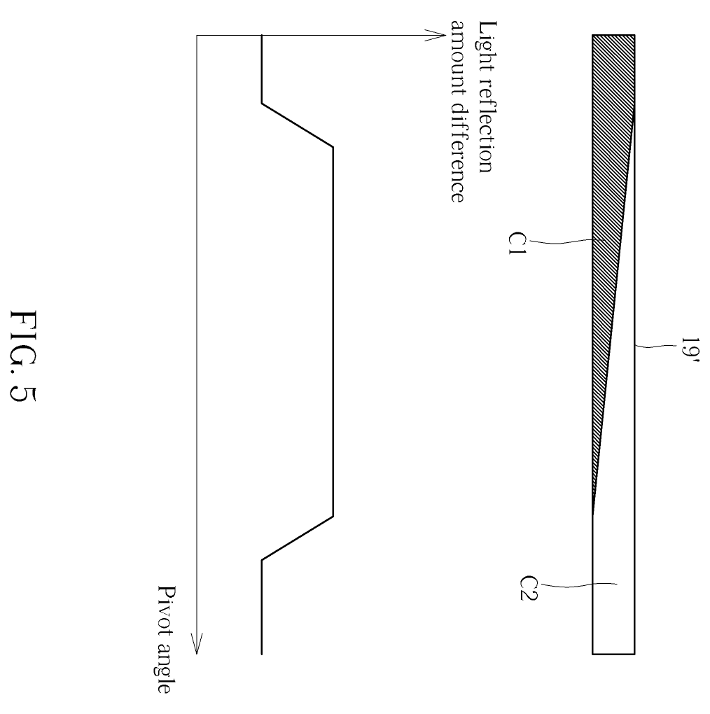

It should be mentioned that the component configuration of the optical sensing device and the pattern design of the present invention are not limited to the aforesaid embodiments, meaning that the present invention could adopt a color proportion variation design and a dual-receiver configuration. For example, please refer to FIGS. 4 and 5. FIG. 4 is a side view of an electronic device 10’ according to another embodiment of the present invention. FIG. 5 shows a color variation pattern 19’ of a pivot sleeve 18’ in FIG. 4 and the correspondence between the light reflection amount difference and pivot angle of the pivot sleeve 18’. Components with the same reference numerals both mentioned in this embodiment and the aforesaid embodiments represent components with the same or similar functions or structures, and the related description is omitted herein.

As shown in FIGS. 4 and 5, the electronic device 10’ includes the first device body 12, the second device body 14, the pivot base 16, the pivot sleeve 18’, and an optical sensing device 20’. The pivot sleeve 18’ is sleeved at the pivotal connection position between the pivot base 16 and the second device body 14 and formed with the color variation pattern 19’. The optical sensing device 20’ could be disposed on the pivot base 16 (but not limited thereto, meaning that the optical sensing device 20’ could be disposed on the first device body 12 in another embodiment) and includes the optical emitting component 22 and an optical receiving component 24’. The optical receiving component 24’ includes a first receiving sub-component 241 and a second receiving sub-component 242 facing each other. A connecting line between the first receiving sub-component 241 and the second receiving sub-component 242 could be perpendicular to an axial direction of the pivot sleeve 18’ (but not limited thereto, meaning that the connecting line could be not parallel to the axial direction in another embodiment). The color variation pattern 19’ could have a first color C1 (e.g., black) corresponding to a low light reflection amount and a second color C2 (e.g., white) corresponding to a high light reflection amount. A coating area ratio of the first color C1 to the second color C2 on the pivot sleeve 18’ could decrease gradually along a periphery of the pivot sleeve 18’. Via the aforesaid design, when the pivot sleeve 18’ pivots, the first receiving sub-component 241 and the second receiving sub-component 242 can respectively receive light reflected from the color variation pattern 19’, such that the optical sensing device 20’ can generate an optical sensing signal corresponding to a light reflection amount difference received by the first receiving sub-component 241 and the second receiving sub-component 242.

For example, during the process of the second device body 14 pivoting together with the pivot sleeve 18’ relative to the first device body 12, if the second device body 14 pivots to the folded position such that the light from the optical emitting component 22 is incident upon a section located at a leftmost portion of the color variation pattern 19’ as shown in FIG. 5, the light reflection amount difference received by the first receiving sub-component 241 and the second receiving sub-component 242 is small. Accordingly, the optical sensing device 20’ can determine that the second device body 14 has currently pivoted to the folded position (e.g., using whether the light reflection amount difference is lower than a predetermined value as a determination basis), and thus proceed with subsequent control operations, such as triggering a shutdown procedure or entering a sleep mode.

On the other hand, if the second device body 14 pivots to the unfolded position such that the light from the optical emitting component 22 is incident upon a middle section of the color variation pattern 19’ as shown in FIG. 5, the light reflection amount difference received by the first receiving sub-component 241 and the second receiving sub-component 242 is large. Accordingly, the optical sensing device 20’ can determine that the second device body 14 has currently pivoted to the unfolded position (e.g., using whether the light reflection amount difference is higher than a predetermined value as a determination basis), and thus proceed with subsequent control operations, such as triggering a booting procedure. To be noted, the component configuration of the optical sensing device and the pattern design mentioned in the aforesaid embodiments could be applied to each other, and the related description could be reasoned by analogy according to FIGS. 1, 3, 4, and 5, and omitted herein.

Similarly, in another embodiment, the present invention could adopt the pattern design in which the optical sensing device 20’ can determine that the second device body 14 has currently pivoted to the folded position when the light is incident upon a section with a large light reflection amount difference within a color variation pattern, and determine that the second device body 14 has currently pivoted to the unfolded position when the light is incident upon a section with a small light reflection amount difference within the color variation pattern. The detailed description for this embodiment could be reasoned by analogy according to FIG. 5 and omitted herein. As for which pattern design is adopted, it depends on the practical applications of the present invention.

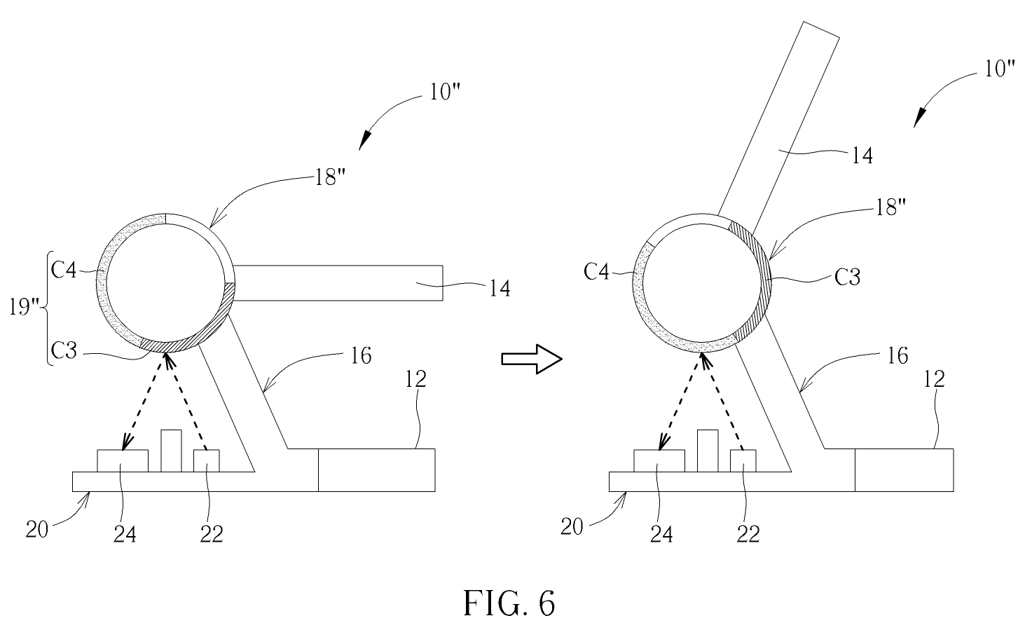

In addition, the present invention could also adopt a pattern design with sequential dual-color coating. For example, please refer to FIG. 6, which is a side view of an electronic device 10” according to another embodiment of the present invention. Components with the same reference numerals both mentioned in this embodiment and the aforesaid embodiments represent components with the same or similar functions or structures, and the related description is omitted herein.

As shown in FIG. 6, the electronic device 10” includes the first device body 12, the second device body 14, the pivot base 16, a pivot sleeve 18”, and the optical sensing device 20. The pivot sleeve 18” is sleeved at the pivotal connection position between the pivot base 16 and the second device body 14 and formed with a color variation pattern 19”. The color variation pattern 19” has a first color C3 (e.g., black, but not limited thereto) corresponding to a low light reflection amount and a second color C4 (e.g., yellow, but not limited thereto) corresponding to a high light reflection amount. The first color C3 and the second color C4 could be sequentially coated on the pivot sleeve 18” along a periphery of the pivot sleeve 18”.

Via the aforesaid design, during the process of the second device body 14 pivoting together with the pivot sleeve 18” relative to the first device body 12, if the second device body 14 pivots to the folded position (as shown in a left half portion of FIG. 6) such that the light from the optical emitting component 22 is incident upon a section of the color variation pattern 19” corresponding to the first color C3, the optical receiving component 24 receives a lower light reflection amount. Accordingly, the optical sensing device 20 can determine that the second device body 14 has currently pivoted to the folded position, and thus proceed with subsequent control operations, such as triggering a shutdown procedure or entering a sleep mode. On the other hand, if the second device body 14 pivots to the unfolded position (as shown in a right half portion of FIG. 6) such that the light from the optical emitting component 22 is incident upon the section of the color variation pattern 19” corresponding to the second color C4, the optical receiving component 24 receives a higher light reflection amount. Accordingly, the optical sensing device 20 can determine that the second device body 14 has currently pivoted to the unfolded position, and thus proceed with subsequent control operations, such as triggering a booting procedure.

Similarly, in another embodiment, the present invention could adopt the pattern design in which the optical sensing device 20 can determine that the second device body 14 has currently pivoted to the folded position when the light is incident upon a section with a higher light reflection amount within a color variation pattern, and determine that the second device body 14 has currently pivoted to the unfolded position when the light is incident upon a section with a lower light reflection amount within the color variation pattern. The detailed description for this embodiment could be reasoned by analogy according to FIG. 6 and omitted herein. As for which pattern design is adopted, it depends on the practical applications of the present invention.

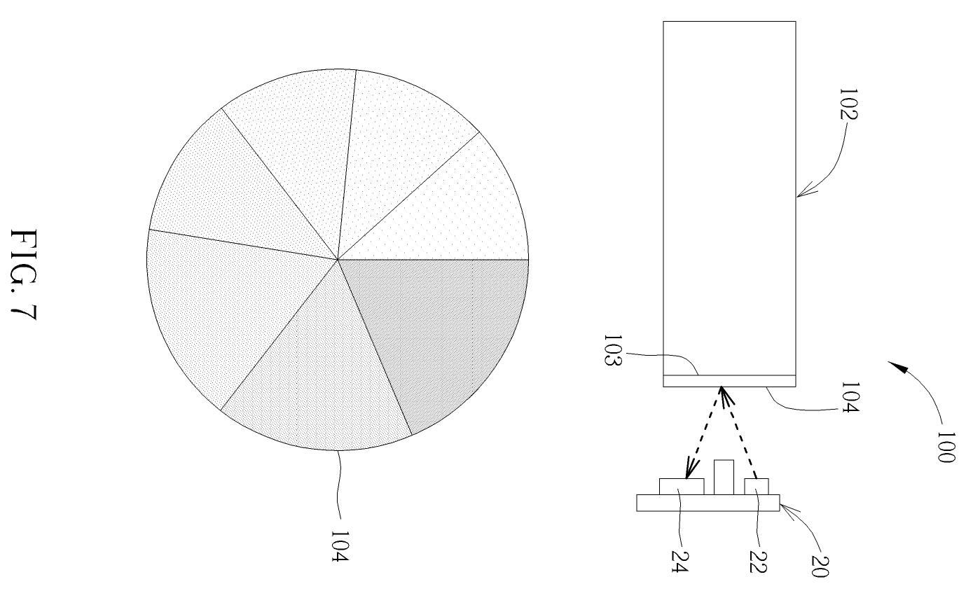

Moreover, the present invention could also adopt a design that the color variation pattern is formed on an end surface of the pivot sleeve. For example, please refer to FIG. 7, which is a side view of an electronic device 100 according to another embodiment of the present invention. Components with the same reference numerals both mentioned in this embodiment and the aforesaid embodiments represent components with the same or similar functions or structures, and the related description is omitted herein.

For clearly showing the relative position relationship between the pivot sleeve and the optical sensing device, other components of the electronic device 100 are omitted in FIG. 7. As shown in FIG. 7, the electronic device 100 includes the first device body 12, the second device body 14, the pivot base 16, a pivot sleeve 102, and the optical sensing device 20. The pivot sleeve 102 is sleeved at the pivotal connection position between the pivot base 16 and the second device body 14, and a color variation pattern 104 is formed on an end surface 103 of the pivot sleeve 102 and presents a color gradient distribution, such as a grayscale gradient distribution or a gradient distribution from dark to light (e.g., a gradient distribution from dark green to light green, but not limited thereto). The optical sensing device 20 is disposed on the pivot base 16 or the first device body 12 at a position facing the end surface 103.

Via the aforesaid design, during the process of the second device body 14 pivoting together with the pivot sleeve 102 relative to the first device body 12, if the second device body 14 pivots to the folded position such that the light from the optical emitting component 22 is incident upon a section having a higher grayscale value (or a darker color) within the color variation pattern 104, the optical receiving component 24 receives a lower light reflection amount. Accordingly, the optical sensing device 20 can determine that the second device body 14 has currently pivoted to the folded position, and thus proceed with subsequent control operations, such as triggering a shutdown procedure or entering a sleep mode. On the other hand, if the second device body 14 pivots to the unfolded position such that the light from the optical emitting component 22 is incident upon a section having a lower grayscale value (or a lighter color) within the color variation pattern 104, the optical receiving component 24 receives a higher light reflection amount. Accordingly, the optical sensing device 20 can determine that the second device body 14 has currently pivoted to the unfolded position, and thus proceed with subsequent control operations, such as triggering a booting procedure.

Similarly, in another embodiment, the present invention could adopt the pattern design in which the optical sensing device 20 can determine that the second device body 14 has currently pivoted to the folded position when the light is incident upon a section having a lower grayscale value (or a lighter color) within a color variation pattern, and determine that the second device body 14 has currently pivoted to the unfolded position when the light is incident upon a section having a higher grayscale value (or a darker color) within the color variation pattern. The detailed description for this embodiment could be reasoned by analogy according to FIG. 7 and omitted herein. As for which pattern design is adopted, it depends on the practical applications of the present invention.

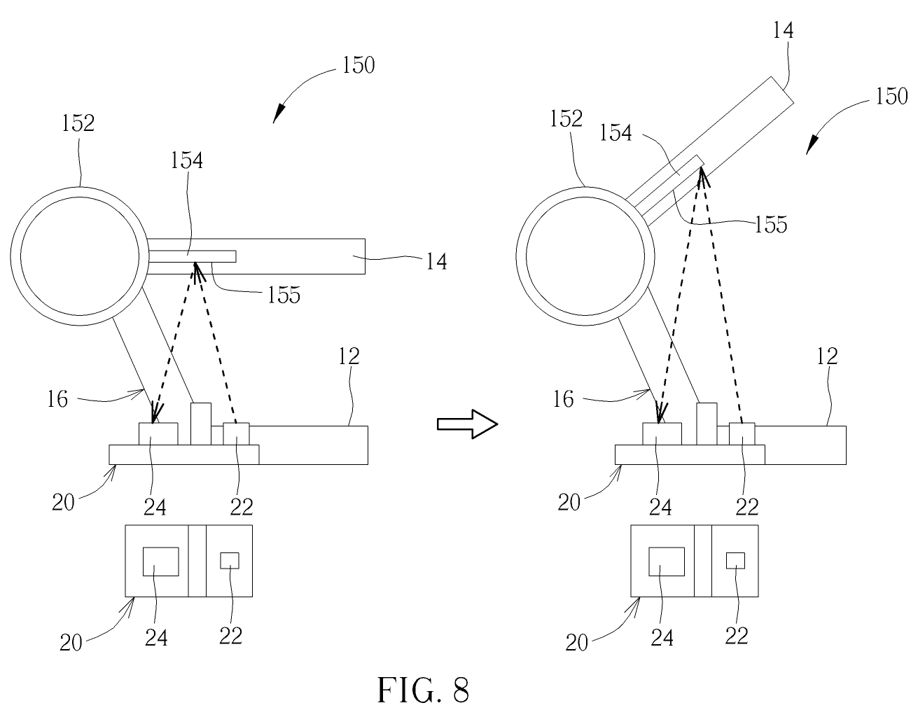

In practical applications, the present invention could also adopt a design of forming a reflective structure on the pivot sleeve. For example, please refer to FIG. 8, which is a side view of an electronic device 150 according to another embodiment of the present invention. Components with the same reference numerals both mentioned in this embodiment and the aforesaid embodiments represent components with the same or similar functions or structures, and the related description is omitted herein.

As shown in FIG. 8, the electronic device 150 includes the first device body 12, the second device body 14, the pivot base 16, a pivot sleeve 152, and the optical sensing device 20. The pivot sleeve 152 is sleeved at the pivotal connection position between the pivot base 16 and the second device body 14 and formed with a reflective structure 154. In this embodiment, the reflective structure 154 could be a protrusion extending outward from a periphery of the pivot sleeve 152 and having a reflective surface 155, so as to reflect the light emitted by the optical emitting component 22 to the optical receiving component 24 at different reflection angles as the pivot sleeve 152 pivots.

Via the aforesaid design, during the process of the second device body 14 pivoting together with the pivot sleeve 152 relative to the first device body 12, if the second device body 14 pivots to the folded position such that the light from the optical emitting component 22 is incident upon the reflective surface 155 at an angle as shown in a left half portion of FIG. 8, the optical receiving component 24 receives a higher light reflection amount. Accordingly, the optical sensing device 20 can determine that the second device body 14 has currently pivoted to the folded position (e.g., using whether the light reflection amount is higher than a predetermined value as a determination basis), and thus proceed with subsequent control operations, such as triggering a shutdown procedure or entering a sleep mode. On the other hand, if the second device body 14 pivots to the unfolded position such that the light from the optical emitting component 22 is incident upon the reflective surface 155 at an angle as shown in a right half portion of FIG. 8, the optical receiving component 24 receives a lower light reflection amount. Accordingly, the optical sensing device 20 can determine that the second device body 14 has currently pivoted to the unfolded position (e.g., using whether the light reflection amount is lower than a predetermined value as a determination basis), and thus proceed with subsequent control operations, such as triggering a booting procedure.

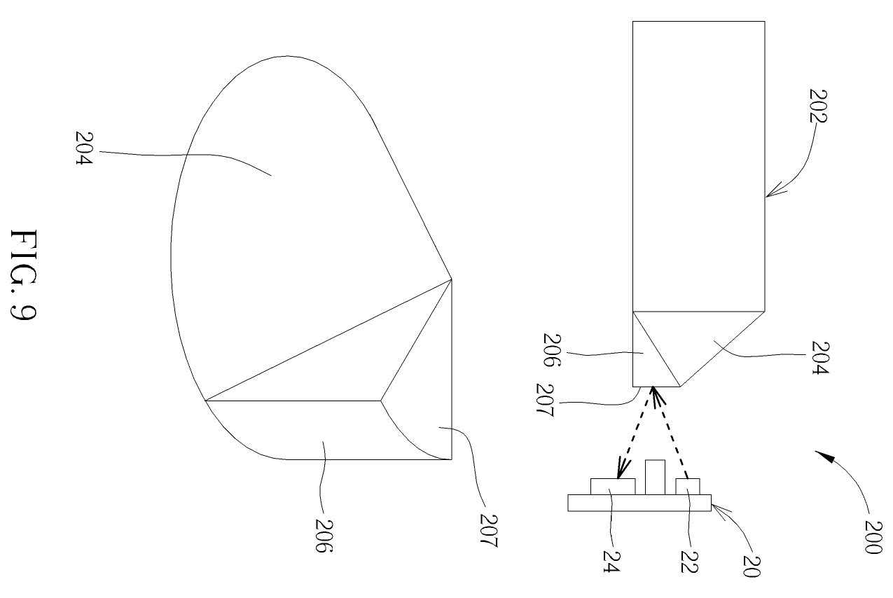

Furthermore, the reflective structural design of the present invention is not limited to the aforesaid embodiment, meaning that the present invention could also adopt a pivot end reflection design. For example, please refer to FIG. 9, which is a side view of an electronic device 200 according to another embodiment of the present invention. Components with the same reference numerals both mentioned in this embodiment and the aforesaid embodiments represent components with the same or similar functions or structures, and the related description is omitted herein.

For clearly showing the relative position relationship between the pivot sleeve and the optical sensing device, other components of the electronic device 200 are omitted in FIG. 9. As shown in FIG. 9, the electronic device 200 includes the first device body 12, the second device body 14, the pivot base 16, a pivot sleeve 202, and the optical sensing device 20. The pivot sleeve 202 is sleeved at the pivotal connection position between the pivot base 16 and the second device body 14 and has a pyramidal end portion 204 and a reflective structure 206. The optical sensing device 20 is disposed on the pivot base 16 or the first device body 12 at a position facing the pyramidal end portion 204, and the reflective structure 206 could protrude from the pyramidal end portion 204 toward the optical sensing device 20 to form a reflective plane 207.

Via the aforesaid design, during the process of the second device body 14 pivoting together with the pivot sleeve 202 relative to the first device body 12, if the second device body 14 pivots to the folded position such that the light from the optical emitting component 22 is incident upon the pyramidal surface of the pyramidal end portion 204 other than the reflective plane 207, scattering occurs to cause the optical receiving component 24 to receive a lower light reflection amount. Accordingly, the optical sensing device 20 can determine that the second device body 14 has currently pivoted to the folded position, and thus proceed with subsequent control operations, such as triggering a shutdown procedure or entering a sleep mode. On the other hand, if the second device body 14 pivots to the unfolded position such that the light from the optical emitting component 22 is incident upon the reflective plane 207 (as shown in FIG. 9), the optical receiving component 24 receives a higher light reflection amount. Accordingly, the optical sensing device 20 can determine that the second device body 14 has currently pivoted to the unfolded position, and thus proceed with subsequent control operations, such as triggering a booting procedure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device comprising:
a first device body;
a second device body;
a pivot base disposed on the first device body and pivotally connected to the second device body, such that the second device body is pivotable relative to the first device body to an unfolded position or a folded position via the pivot base;
a pivot sleeve sleeved at a pivotal connection position between the pivot base and the second device body to pivot together with the second device body, the pivot sleeve being formed with a color variation pattern or a reflective structure; and
an optical sensing device disposed on the pivot base or the first device body, the optical sensing device comprising an optical emitting component and an optical receiving component;
wherein light emitted by the optical emitting component is incident upon the color variation pattern or the reflective structure and reflected to the optical receiving component when the pivot sleeve pivots, such that the optical sensing device generates an optical sensing signal corresponding to a pivot angle of the pivot sleeve according to at least one light reflection amount received by the optical receiving component.

2. The electronic device of claim 1, wherein the optical receiving component comprises a first receiving sub-component and a second receiving sub-component opposite to each other, and a connecting line between the first receiving sub-component and the second receiving sub-component is not parallel to an axial direction of the pivot sleeve; when the pivot sleeve pivots, the first receiving sub-component and the second receiving sub-component respectively receive the light reflected from the color variation pattern, such that the optical sensing device generates the optical sensing signal according to a light reflection amount difference received by the first receiving sub-component and the second receiving sub-component.

3. The electronic device of claim 2, wherein the connecting line between the first receiving sub-component and the second receiving sub-component is perpendicular to the axial direction of the pivot sleeve.

4. The electronic device of claim 1, wherein the color variation pattern is distributed in a grayscale gradient along a periphery of the pivot sleeve.

5. The electronic device of claim 1, wherein the color variation pattern has a first color and a second color different from the first color, and a coating area ratio of the first color to the second color on the pivot sleeve gradually decreases along a periphery of the pivot sleeve.

6. The electronic device of claim 1, wherein the color variation pattern has a first color and a second color different from the first color, and the first color and the second color are sequentially coated on the pivot sleeve along a periphery of the pivot sleeve.

7. The electronic device of claim 1, wherein the color variation pattern is formed on an end surface of the pivot sleeve and is distributed in a color gradient, and the optical sensing device is disposed on the pivot base or the first device body at a position facing the end surface.

8. The electronic device of claim 1, wherein the reflective structure is a protrusion extending outward from a periphery of the pivot sleeve, and the protrusion has a reflective surface to reflect the light emitted by the optical emitting component to the optical receiving component at different reflection angles as the pivot sleeve pivots.

9. The electronic device of claim 1, wherein the pivot sleeve has a pyramidal end portion, the optical sensing device is disposed on the pivot base or the first device body at a position facing the pyramidal end portion, and a reflective structure protrudes from the pyramidal end portion toward the optical sensing device to form a reflective plane; when the pivot sleeve pivots to align the reflective plane with the optical sensing device, the optical receiving component receives light reflected from the reflective plane, such that the optical sensing device generates the optical sensing signal.

10. The electronic device of claim 1, wherein the optical emitting component is an infrared (IR) emitter, and the optical receiving component is a phototransistor (PT) receiver.

11. A pivot angle sensing method for an electronic device, the electronic device comprising a first device body, a second device body and a pivot base, the pivot base being disposed on the first device body and pivotally connected to the second device body such that the second device body is pivotable relative to the first device body to an unfolded position or a folded position via the pivot base, and the pivot angle sensing method comprising:
emitting light from an optical sensing device toward a pivot sleeve, wherein the pivot sleeve is sleeved at a pivotal connection position between the pivot base and the second device body of the electronic device and is formed with a color variation pattern or a reflective structure;
receiving a reflected light from the color variation pattern or the reflective structure by the optical sensing device as the pivot sleeve pivots together with the second device body; and
generating an optical sensing signal corresponding to a pivot angle of the pivot sleeve according to a light reflection amount received by the optical sensing device.

12. The pivot angle sensing method of claim 11, wherein the optical sensing device comprises an optical receiving component, the optical receiving component comprises a first receiving sub-component and a second receiving sub-component opposite to each other, and a connecting line between the first receiving sub-component and the second receiving sub-component is not parallel to an axial direction of the pivot sleeve; when the pivot sleeve pivots, the first receiving sub-component and the second receiving sub-component respectively receive the light reflected from the color variation pattern, such that the optical sensing device generates the optical sensing signal according to a light reflection amount difference received by the first receiving sub-component and the second receiving sub-component.

13. The pivot angle sensing method of claim 12, wherein the connecting line between the first receiving sub-component and the second receiving sub-component is perpendicular to the axial direction of the pivot sleeve.

14. The pivot angle sensing method of claim 11, wherein the color variation pattern is distributed in a grayscale gradient along a periphery of the pivot sleeve.

15. The pivot angle sensing method of claim 11, wherein the color variation pattern has a first color and a second color different from the first color, and a coating area ratio of the first color to the second color on the pivot sleeve gradually decreases along a periphery of the pivot sleeve.

16. The pivot angle sensing method of claim 11, wherein the color variation pattern has a first color and a second color different from the first color, and the first color and the second color are sequentially coated on the pivot sleeve along a periphery of the pivot sleeve.

17. The pivot angle sensing method of claim 11, wherein the color variation pattern is formed on an end surface of the pivot sleeve and is distributed in a color gradient, and the optical sensing device is disposed on the pivot base or the first device body at a position facing the end surface.

18. The pivot angle sensing method of claim 11, wherein the reflective structure is a protrusion extending outward from a periphery of the pivot sleeve, and the protrusion has a reflective surface to reflect the light emitted by the optical sensing device at different reflection angles as the pivot sleeve pivots.

19. The pivot angle sensing method of claim 11, wherein the pivot sleeve has a pyramidal end portion, the optical sensing device is disposed on the pivot base or the first device body at a position facing the pyramidal end portion, and a reflective structure protrudes from the pyramidal end portion toward the optical sensing device to form a reflective plane; when the pivot sleeve pivots to align the reflective plane with the optical sensing device, the optical sensing device receives light reflected from the reflective plane, such that the optical sensing device generates the optical sensing signal.
